(19) United States
(12) Patent Application Publication
(10) Pub. No.: US 2023/0169665 A1
(43) Pub. Date: Jun. 1, 2023

(54) SYSTEMS AND METHODS FOR TEMPORAL AUTOCALIBRATION IN A CAMERA SYSTEM

(71) Applicant: INTRINSIC INNOVATION LLC, Mountain View, CA (US)

(72) Inventors: Vage TAAMAZYAN, Balashikha, Moscow (RU); Agastya KALRA, Nepean, Ontario (CA); Achuta KADAMBI, Los Altos Hills, CA (US); Kartik VENKATARAMAN, San Jose, CA (US)

(21) Appl. No.: 17/539,625

(22) Filed: Dec. 1, 2021

(51) Int. Cl. G06T 7/292; G06T 7/80; G06V 20/40; G06T 7/70

(52) U.S. Cl. CPC G06T 7/292; G06T 7/80; G06V 20/44; G06T 7/70

(57) ABSTRACT

Systems and methods for calibrating an imaging device. A processing circuit identifies first timestamps of one or more events in one or more first image frames of a first imaging device, and identifies one or more corresponding events in one or more second image frames. Second timestamps may be determined for the corresponding events. A calibration value may be calculated based on a difference between the first and second timestamps. In one embodiment, the processing circuit also identifies a first plurality of events in a first sequence of image frames transmitted by a first imaging device, and selects a second plurality of events in a second sequence of image frames by a second imaging device that minimizes discrepancy between the first plurality of events and the second plurality of events. A calibration value is computed based on the timestamps of the matched events.

### FIELD

Aspects of embodiments of the present disclosure relate to a camera system, and in particular, to automatic temporal calibration of multiple cameras in a multi-camera system.

### BACKGROUND

In many different applications the correct work of multicamera setup requires accurate temporal calibration. Such setups can lose the calibration after, for example, restart of any one of the cameras and/or due to differences in the running frequency of the internal clocks of the cameras. Thus, calibration metrics can drift over time. Manually recalibrating the cameras can be a time-consuming process. It is therefore desirable to have a system and method that automatically recalibrates the cameras from time to time.

The above information disclosed in this Background section is only for enhancement of understanding of the background of the present disclosure, and therefore, it may contain information that does not form prior art.

### SUMMARY

An embodiment of the present disclosure is directed to a method for calibrating an imaging device. A processing circuit processes a first image frame captured by a first imaging device, identifies an event in the first image frame, and determines a first time value of the event. The processing circuit also processes a second image frame captured by a second imaging device, identifies the event in the second image frame, and determines a second time value of the event. The processing circuit calculates a calibration value based on a difference between the first time value and the second time value, and adjusts a time value of a third image frame provided by the second imaging device based on the calibration value.

According to one embodiment, the event is a start or stop of movement of an object through a scene.

According to one embodiment, the first time value is a first timestamp of the first image frame, and the second time value is a second timestamp of the second image frame.

An embodiment of the present disclosure is also directed to a method for calibrating an imaging device that includes: processing, by a processing circuit, a first sequence of image frames transmitted by a first imaging device; identifying, by the processing circuit, a first plurality of events in the first sequence; processing, by the processing circuit, a second sequence of image frames transmitted by a second imaging device; selecting, by the processing circuit, a second plurality of events in the second sequence that minimizes discrepancy between the first plurality of events and the second plurality of events; determining, by the processing circuit, a first plurality of time values corresponding to the first plurality of events, and a second plurality of time values corresponding to the second plurality of events; computing, by the processing circuit, a calibration value based on a difference between the first plurality of time values and the second plurality of time values; and adjusting, by the processing circuit, a time value of a third image frame provided by the second imaging device based on the calibration value.

According to one embodiment, the first plurality of events include start and stop movements of an object through a scene.

According to one embodiment, the first plurality of time values include timestamps of the first sequence of image frames, and the second plurality of time values include timestamps of the second sequence of image frames.

According to one embodiment, the calibration value is an average of a first difference and a second difference, wherein the first difference is between times of first events selected from the first plurality of events and the second plurality of events, and the second difference is between times of second events selected from the first plurality of events and the second plurality of events.

According to one embodiment, the selecting of the second plurality of events includes iteratively aligning the first plurality of events to different ones of the second plurality of events, and iteratively computing discrepancy measurements based on the aligning.

An embodiment of the present disclosure is also directed to a method for calibrating an imaging device comprising: processing, by a processing circuit, a first sequence of image frames transmitted by a first imaging device, wherein one or more of the first sequence of image frames includes first motion-blurred images; computing, by the processing circuit, a first blur kernel for a first image frame in the first sequence of image frames; computing, by the processing circuit, a first movement profile for the first blur kernel; processing, by a processing circuit, a second sequence of image frames transmitted by a second imaging device, wherein one or more of the second sequence of image frames includes second motion-blurred images; computing, by the processing circuit, a second blur kernel for a second image frame in the second sequence of image frames; computing, by the processing circuit, a second movement profile for the second blur kernel; computing, by the processing circuit, a calibration value that minimizes discrepancy between the first movement profile and the second movement profile; and adjusting, by the processing circuit, a timestamp of a third image frame provided by the second imaging device based on the calibration value.

According to one embodiment, the first movement profile and the second movement profile encode linear movements.

An embodiment of the present disclosure is further directed to an imaging system comprising a first imaging device, a second imaging device, and a processing system coupled to the first imaging device and the second imaging device. The processing system comprises a processor and memory storing instructions that, when executed by the processor, cause the processor to perform: processing a first image frame captured by a first imaging device; identifying an event in the first image frame; determining a first time value of the event; processing a second image frame captured by a second imaging device; identifying the event in the second image frame; determining a second time value of the event; calculating a calibration value based on a difference between the first time value and the second time value; and adjusting a time value of a third image frame provided by the second imaging device based on the calibration value.

An embodiment of the present disclosure is also directed to an imaging system comprising a first imaging device, a second imaging device, and a processing system coupled to the first imaging device and the second imaging device. The processing system comprises a processor and memory storing instructions that, when executed by the processor, cause the processor to perform: processing a first sequence of image frames transmitted by a first imaging device; identifying a first plurality of events in the first sequence; processing a second sequence of image frames transmitted by a second imaging device; selecting a second plurality of events in the second sequence that minimizes discrepancy between the first plurality of events and the second plurality of events; determining a first plurality of time values corresponding to the first plurality of events, and a second plurality of time values corresponding to the second plurality of events; computing a calibration value based on a difference between the first plurality of time values and the second plurality of time values; and adjusting a time value of a third image frame provided by the second imaging device based on the calibration value.

An embodiment of the present disclosure is further directed to an imaging system comprising a first imaging device, a second imaging device, and a processing system coupled to the first imaging device and the second imaging device. The processing system includes a processor and memory storing instructions that, when executed by the processor, cause the processor to perform: processing a first sequence of image frames transmitted by a first imaging device, wherein one or more of the first sequence of image frames includes first motion-blurred images; computing a first blur kernel for a first image frame in the first sequence of image frames; computing a first movement profile for the first blur kernel; processing a second sequence of image frames transmitted by a second imaging device, wherein one or more of the second sequence of image frames includes second motion-blurred images; computing a second blur kernel for a second image frame in the second sequence of image frames; computing a second movement profile for the second blur kernel; computing a calibration value that minimizes discrepancy between the first movement profile and the second movement profile; and adjusting a timestamp of a third image frame provided by the second imaging device based on the calibration value.

It should be appreciated that the claimed system and method enable temporal autocalibration of a camera in a multi-camera setup based on one or more events captured in a scene. It should further be appreciated that the claimed autocalibration system and method do not require special calibration objects and avoid disabling of the multicamera setup to do the calibration.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a schematic block diagram of an imaging system configured to execute one or more autocalibration methodologies according to one embodiment;

FIG. 2 is a conceptual diagram of an example stop event that may be used for a rough autocalibration mechanism according to one embodiment;

FIG. 3 is flow diagram of a process for rough temporal autocalibration of a second imaging device to a first imaging device according to one embodiment;

FIG. 4 is a conceptual diagram of an example of subframe time discrepancy between a main camera and a support camera;

FIGS. 5A-5B are conceptual diagrams of a process for matching multiple events detected by a main camera a support cameras, for performing subframe autocalibration based on the matched events according to one embodiment;

FIG. 6 is flow diagram of a process for subframe temporal autocalibration of a second imaging device to a first imaging device according to one embodiment;

FIG. 7 is flow diagram of a process for temporal autocalibration of a second imaging device to a first imaging device in the presence of motion blur according to one embodiment;

FIG. 8 is a more detailed flow diagram for computing a 1D movement profile based on a blur kernel according to one embodiment;

FIGS. 9A-9B are pictures of an exemplary motion blur kernel according to one embodiment; and

FIG. 10 is a graph of an example 1D movement profile according to one embodiment.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

In a multi-camera system, an object moving through a scene may be captured by multiple cameras from multiple viewpoints at a known framerate. In order to restore certain information about the moving object, including, for example, position of the object in six degrees of freedom (6DOF), direction and speed of the object, and the like, it is desirable for the cameras to be temporally and spatially calibrated. Temporal calibration may be synchronization of timestamps given to captured video image frames by a group of N cameras such that the multi-camera system imaging the same scene can identify N different video image frames depicting the object at a same moment in time from different viewpoints.

Initial calibration of the cameras may eventually drift over time due, for example, the cameras being turned off and on and/or due to differences in the running frequencies of the internal clocks (e.g., due differences in frequencies within engineering tolerances, due to temperature differences, and due to aging of components of the clock circuits), and the initial calibration metric may lose its relevance. Recalibrating the cameras manually may be a time-consuming process. Accordingly, it is desirable to have an automatic system and method for recalibrating the cameras.

In general terms, embodiments of the present disclosure are directed to a multi-camera system that is configured to engage in temporal autocalibration and/or calibration refinement (collectively referred to as autocalibration) of N cameras of the system, based on one or more detected events of a captured scene. In one embodiment, movement of an object across the scene may be used for the temporal autocalibration. For example, start and/or stop movements of an object transported on a conveyor belt may be monitored and used for the temporal autocalibration. Although the various embodiments described herein assume that the monitored movement is that of an object on a conveyor belt, a person of skill in the art should recognize that the monitored movement may be any linear movement of the object across a scene.

In one embodiment, two or more cameras in the multi-camera system capture images of the object moving across the scene, from multiple viewpoints. In one embodiment, an assumption is made that the image frames are captured with low enough (or short enough) exposure time so that any motion blur may be neglected in the captured video frames. Based on this assumption, temporal autocalibration may be performed, according to one embodiment, based on one or more detectable events captured by the video frames. The detectable event may be a detected start and/or stop of movement of the object on a conveyor belt.

In one embodiment, a first autocalibration methodology is employed by the camera system to calculate a temporal calibration value for the cameras when only a single event is detected. In this regard, one of the N cameras is selected as a main camera to which other cameras are synchronized. In synchronizing a support camera of the N cameras with the main camera, timestamps of the video frames that captured the detectable event are identified for both the main camera and the support camera. A difference of the two timestamps is set to be as the calibration value for the support camera. According to the first methodology, the temporal calibration value is equal or greater than the time per frame.

In one embodiment, a second autocalibration methodology is employed by the camera system to calculate a temporal calibration value for the cameras when multiple events are detected. The second autocalibration methodology may allow detection of temporal discrepancies between cameras that may be below the time per frame (e.g., temporal discrepancies that are shorter than the length of a frame). Such a discrepancy may be referred to as a subframe discrepancy, and the calculated temporal calibration value may be referred to as a subframe temporal calibration value.

In one embodiment, the calculating of the subframe temporal calibration value includes computing a temporal calibration value that best aligns the events captured by the main camera with the events captured by the support camera. In one embodiment, one or more tentative subframe temporal calibration values are computed based on one or more attempts to match the events detected by the two cameras, and an error/discrepancy metric is computed based on each of the computed tentative subframe temporal calibration values. The error metric may be the sum of discrepancy values of the matched events as corrected by the tentative subframe temporal calibration value. In one embodiment, the computed subframe temporal calibration value that minimizes the error metric is selected as the actual subframe temporal calibration value for the support camera.

In one embodiment, a third autocalibration methodology is used by the camera system for calculating a temporal calibration value in the presence of motion blur effect on the video frames. The motion blur may be due to the object moving with respect to the camera during the recording of a single exposure. In this case, the object moving with respect to the camera will look blurred or smeared along the direction of relative motion. In one example, the longer the exposure window/time, the bigger the motion blur.

In one embodiment, the camera system computes an estimated motion blur kernel that describes the object motion during an exposure window. An unblurred or latent image may be estimated via a deconvolution algorithm using the estimated motion blur kernel and the captured blurry image.

In the event of linear movement through the scene, the motion blur kernel may take the form of one or more linear strokes. The linear strokes may be converted into a one-dimensional (1D) movement profile. In computing the temporal calibration value, an aggregated movement profile of the main camera for multiple frames is compared against the aggregated movement profile of the support camera for multiple frames, and a calibration value is selected that minimizes the discrepancy/error between the two aggregated movement profiles.

In one embodiment, one or more of the autocalibration methodologies are run concurrently with each other, or in series. For example, the first autocalibration methodology may be run to roughly compute a first temporal calibration value, and the second autocalibration may also be run to compute any subframe discrepancy that is less than the time per frame.

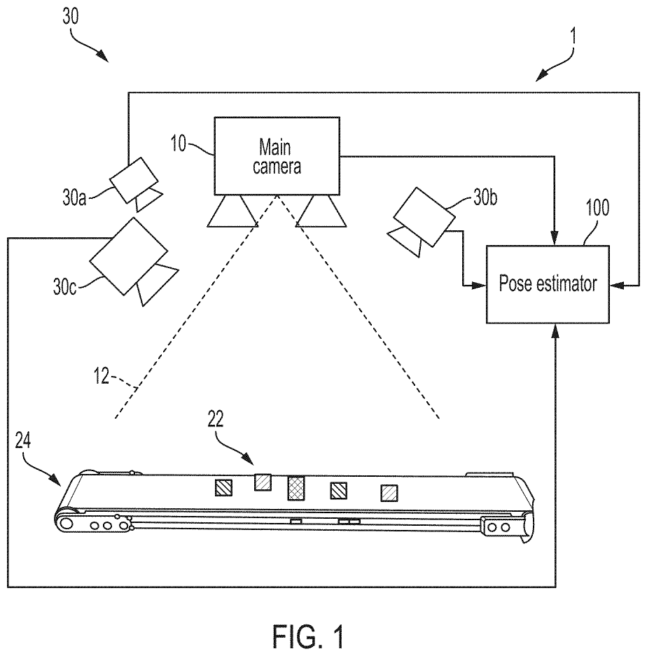

FIG. 1 is a schematic block diagram of an imaging system configured to execute one or more autocalibration methodologies according to one embodiment. The system may include a first/main camera (first imaging device) 10 and one or more second/support cameras 30a-30c (second imaging devices) (collectively referenced as 30).

In one embodiment, the main camera 10 includes a stereo camera. Examples of stereo cameras include camera systems that have at least two monocular cameras spaced apart from each other along a baseline, where the monocular cameras have overlapping fields of view and optical axes that are substantially parallel to one another. The support cameras 30 may be stereo cameras, monocular cameras, or combinations thereof (e.g., some stereo support cameras and some monocular support cameras). The main camera 10 and the support cameras 30 may use the same imaging modalities or different imaging modalities. Examples of imaging modalities include monochrome, color, infrared, ultraviolet, thermal, polarization, and combinations thereof.

In the embodiment of FIG. 1, the main camera 10 and the support cameras are arranged such that their field of view 12 captures a scene with an object 22 transported on a carrying medium 24 such as, for example, a conveyor belt. Although a conveyor belt is used as an example, embodiments of the present disclosure are not limited thereto, and may include other carrying mediums such as, for example, a movable arm of a robot and/or the like.

In one embodiment, the main camera 10 is located above the carrying medium 24 (e.g., spaced apart from the objects 22 along the direction of gravity). In some embodiments, the main camera is located at other positions and/or orientations. For example, the main camera may be arranged to have a downward angled view of the objects 22.

In some embodiments, the support cameras 30 are arranged at different poses around the carrying medium 24 transporting the objects 22. Accordingly, each of the support cameras 30, e.g., first support camera 30a, second support camera 30b, and third support camera 30c, captures a different view of the objects 22 from a different view point (e.g., a first viewpoint, a second viewpoint, and a third viewpoint, respectively). While FIG. 1 shows three support cameras 30, embodiments of the present disclosure are not limited thereto, and may include, for example, at least one support camera 30 and may include more than three support cameras 30.

In one embodiment, the main camera 10 and the support cameras 30 each include a clock used to assign timestamps to the image frames captured by the corresponding camera. Although initially the clocks of the various cameras may be calibrated/synchronized to each other, over time, the clocks may become uncalibrated/unsynchronized. For example, one of the cameras may be turned off and then on, causing that camera to become temporally uncalibrated. As another example, one camera may be regularly exposed to direct sunlight while another camera remains shaded, such that they consistently operate at different temperatures or component aging at different rates, thereby causing clock drift due to shifts in the resonant frequencies of their clock circuits.

In one embodiment, the multi-camera system includes an autocalibration system 100 configured to perform temporal autocalibration of one or more of the cameras. The autocalibration may occur on a scheduled basis (e.g. every hour, day, week, etc.), or upon detecting a certain event. For example, the event may be one of the cameras 10, 30 turning on after being off.

In one embodiment, the autocalibration system 100 may be configured to compute/estimate temporal autocalibration values for the main and/or support cameras 10, 30, based on information captured by the cameras. The autocalibration system 100 may include processing circuits or electronic circuits configured to compute or estimate temporal autocalibration values for the main and/or support cameras 10, 30. Types of electronic circuits may include a central processing unit (CPU), a graphics processing unit (GPU), an artificial intelligence (AI) accelerator (e.g., a vector processor, which may include vector arithmetic logic units configured efficiently perform operations common to neural networks, such dot products and softmax), a field programmable gate array (FPGA), an application specific integrated circuit (ASIC), a digital signal processor (DSP), or the like. For example, in some circumstances, aspects of embodiments of the present disclosure are implemented in program instructions that are stored in a non-volatile computer readable memory where, when executed by the electronic circuit (e.g., a CPU, a GPU, an AI accelerator, or combinations thereof), perform the operations described herein to compute the temporal autocalibration values.

The operations performed by the autocalibration system 100 may be performed by a single electronic circuit (e.g., a single CPU, a single GPU, or the like) or may be allocated between multiple electronic circuits (e.g., multiple GPUs or a CPU in conjunction with a GPU). The multiple electronic circuits may be local to one another (e.g., located on a same die, located within a same package, located in one or more of the main camera 10 or support cameras 30, or located within a same embedded device or computer system) and/or may be remote from one other (e.g., in communication over a network such as a local personal area network such as Bluetooth®, over a local area network such as a local wired and/or wireless network, and/or over wide area network such as the internet, such a case where some operations are performed locally and other operations are performed on a server hosted by a cloud computing service). One or more electronic circuits operating to implement the autocalibration system 100 may be referred to herein as a computer or a computer system, which may include memory storing instructions that, when executed by the one or more electronic circuits, implement the systems and methods described herein.

In one embodiment, the autocalibration system 100 is configured to control the main camera 10 and the support cameras 30 to stream images of the objects transported via the carrying medium 24 from different viewpoints. The autocalibration system 100 may identify one or more events from the streamed images, and the identified events may then be used to calibrate the cameras 10, 30 so that they are temporally synchronized. In this regard, one of the cameras 10, 30 may be selected as a main camera to serve as the basis of the temporal calibration, and the remaining cameras may be calibrated to the main camera. The selection of main camera may be, for example, random. For ease of description, the main camera 10 is assumed to be the main camera, and the support cameras 30 are assumed to be the cameras that are calibrated to the main camera.

In one embodiment, the autocalibration system 100 processes the videos streamed by the main camera 10, support cameras 30, or a combination of the main camera and the support cameras, during a span of time, for identifying an event. The monitored span of time may be, for example, the time span between a switch on and switch off events between two cameras. The monitored event may be, for example, starting or stopping of movement of one of the objects 22 on the carrying medium 24. Other events that are simultaneously detectable by the main camera and the support cameras may also be monitored and identified in addition or in lieu of start and stop events. For example, brief flashes of light (that may be intentionally projected to help with synchronization), jostling in a direction perpendicular to the movement of the carrying medium 24, reversal of direction of movement of the carrying medium 24, and/or the like may also be monitored and used for calibrating the cameras.

In one embodiment, the autocalibration system 100 is configured with an optical flow algorithm, key point detection algorithm, and/or the like, for identifying a particular event. For example, the optical flow algorithm may be invoked for detecting the movement of an object between successive image frames of a video. The direction of movement and velocity may produce optical flow. Thus, through the detection of optical flow, the movement of an object may be determined for identifying moments in which the movements start, end, and/or take another predefined action.

In general terms, optical flow relates to the distribution of apparent velocities of movement of brightness patterns in an image (see, e.g., Horn, Berthold K P, and Brian G. Schunck. “Determining optical flow.” Artificial intelligence 17.1-3 (1981): 185-203.). One common use of optical flow relates to detecting the movement of objects between successive image frames of a video, such as detecting the motion of a soccer ball based on the change of position of the brightness patterns associated with the ball (e.g., black and white patches) from one frame to the next. An optical flow map may represent the velocities of each pixel value in a first image frame to a corresponding pixel in the second image frame. For example, the brightness at a point (x, y) in the first image at time t may be denoted as E(x, y, t), and this pixel may move by some distance (Δx, Δy) from time t associated with the first image frame to time t+Δt associated with the second frame. Accordingly, the optical flow map may include a velocity (u, v) for each point (x, y) in the first image frame, where u=dx/dt and v=dy/dt. One aspect of algorithms for computing optical flow fields relates to determining correct correspondences between pairs of pixels in the two images. For example, for any given point (x, y) in the first image, there may be many pixels in the second image having the same brightness, and therefore an optical flow algorithm will need to determine which pixel in the second image corresponds to the point (x, y) of the first image, even if the corresponding point in the second image has a different brightness or appearance due to changes in lighting, noise, or the like.

Movement of an object may also be detected using a keypoint detection algorithm. The keypoint detection algorithm may be invoked to detect keypoints (e.g. unique parts) of the object 22. The keypoints may be detected using, for example, a classical keypoint detector (e.g., scale-invariant feature transform (SIFT), speeded up robust features (SURF), gradient location and orientation histogram (GLOH), histogram of oriented gradients (HOG), basis coefficients, or Haar wavelet coefficients) or a trained deep learning keypoint detector such as a trained convolutional neural network using HRNet (Wang, Jingdong, et al. “Deep high-resolution representation learning for visual recognition.” IEEE transactions on pattern analysis and machine intelligence (2020).) with a differential spatial to numerical (DSNT) layer and Blind Perspective-n-Point (Campbell, Dylan, Liu, and Stephen Gould. “Solving the Blind Perspective-n-Point Problem End-To-End With Robust Differentiable Geometric Optimization.” European Conference on Computer Vision. Springer, Cham, 2020).

In one embodiment, the autocalibration system 100 monitors the position of the keypoints in successive frames of the video streamed by the main camera 10 and/or support camera 30 for determining, for example, start or stop of movement of the object. For example, if the position of the keypoints identified for the object 22 remain the same in two consecutive frames, but change in a following frame, a “start movement” event may be identified for the following frame.

In one embodiment, the autocalibration system 100 employs one or more autocalibration methodologies for calibrating the support cameras 30 to the main camera 10. The methodology that is selected may be based on an identified number of detectable events in the streamed video during a span of time, and further based on the identified camera exposure time. In one embodiment, the autocalibration system 100 employs rough temporal calibration if a single event is detected in the streamed video(s) during the span of time. In this regard, in response to detecting the single event by the autocalibration system 100 (e.g. in the main camera 10), a matching event is identified in an image frame streamed by one of the other cameras (e.g. one of the support cameras 30). A timestamp of the event/moment m when the event is identified on the video stream of camera i may be defined as t_{m,i} (e.g., the timestamp of the frame captured by camera i corresponding to the moment m of the event). The rough calibration value for camera i (Δt_{i,Rough}) may then be computed by subtracting the timestamp of the moment of support camera i, from the timestamp of the moment of the main camera 0 (e.g., the timestamp of the frame captured by main camera 0 corresponding the moment m of the event), as follows:

Δt_{i,Rough}=t_{m,0}−t_{m,i}.

In one embodiment, if multiple events are detected by the autocalibration system 100 during the span of time, the autocalibration system 100 engages in subframe temporal calibration for each support camera 30 in relation to the main camera 10. In this regard, in calculating a subframe temporal calibration value for each support camera i 30, the autocalibration system 100 processes a first sequence of image frames transmitted by the main camera 10, and a second sequence of image frames transmitted by support camera i 30. The autocalibration system 100 may detect multiple events in the first sequence of image frames (e.g. one or more start and stop events). In one embodiment, the autocalibration system 100 takes a first plurality of events detected by the main camera 10 and matches it with a second plurality of events detected by support camera i 30. For example, the autocalibration system may take the first two detected events of the main camera 10, and match it to the last two corresponding events (e.g. by matching a start event with a start event, and stop event with a stop event) of the support camera i 30. In one embodiment, the autocalibration system 100 attempts different matches until it finds a match that minimizes a discrepancy computation (or error) between the timestamps of the first plurality of events and the second plurality of events. The matching may be done, for example, by trying all possible combinations until an optimal match is found.

In one embodiment, the autocalibration system 100 computes a tentative calibration value using a first tentative match of the events. The tentative calibration value for camera i(Δtᵢ) may be an average of the temporal discrepancies between the timestamps of the first and second plurality of events, according to the following equation:

$${Δ t}_{i} = \frac{{\sum }_{e} ( {t}_{e , 0} - {t}_{e , i} )}{n} ,$$

where n is the number of matched events, t_{e,0} is the timestamp of an event detected by the main camera 10, and t_{e,i} is the timestamp of a matched event detected by camera i.

Based on the tentative calibration value, the autocalibration system 100 computes a discrepancy/error E value based on the tentative calibration value according to the following formula:

E=Σₑ(t_{e,0}−t_{e,i}−Δtᵢ)²

In one embodiment, different matches of the events detected by the main camera 10 are attempted, and a discrepancy value computed for each of the attempts. For example, during a second iteration of the match, the matching process may move to match different (e.g., earlier) set of events detected by camera i with the events captured by the main camera 10, and attempt more matches of events between the main camera 10 and camera i. A set of matches that provides a minimal discrepancy value is selected, and the associated calibration value is set to be the final calibration value for camera i.

In one embodiment, the autocalibration system 100 employs a motion blur-based temporal calibration in the event that the image frames transmitted by the cameras include motion-blurred images. The motion blur may be due to motion of an object being recorded during a single exposure. In one embodiment, the exposure time is assumed to be more than 50% of the time per frame in order to guarantee overlap of exposures between the main camera and the support camera. That is, if the exposure time is equal or less than 50%, the problem may become ill-posed. For example, if camera 1 is exposed to the first half of the time per frame, and camera 2 is exposed to the second half, then there is no overlap between the two cameras. Thus, in one embodiment, the motion blur-based temporal calibration is employed when the exposure time is more than 50% in order to guarantee at least some overlap between the cameras.

In one embodiment, the autocalibration system 100 processes the blurred image frames transmitted by the main 10 and the support cameras 30, and computes a motion blur kernel for each image frame based on the motion-blurred image captured in the frame. The motion blur kernel may encode the movement of the camera and objects 22 in the scene. In the embodiment where the movement of the objects 22 is linear (e.g. on the carrying medium 24) through the scene, the blur kernel may capture the movement as one or more linear strokes.

In one embodiment, the autocalibration system 100 converts the blur kernel into a movement profile. In one embodiment, the movement profile xᵢ is a 1 D movement profile defined as a function:

xᵢ=x(t),

In this regard, the linear stroke(s) in the blur kernel are converted into a vector of value(s) based on the value(s) of the pixel(s) in the motion blur kernel. For example, pixels with higher brightness may indicate a faster movement than pixels with lower brightness, and may be converted to a value that is greater than the pixels with the lower brightness.

In one embodiment, the movement profiles of the various frames of camera i are combined to generate a single combined movement profile. Similarly, the movement profiles of the various frames of the main camera 10 are combined to generate a single combined movement profile. In one embodiment, a calibration value for camera i(Δtᵢ) is computed so that the following error value E is minimized:

E=Σc₀cᵢ(Δtᵢ)(x₀−xᵢ(Δtᵢ)),

where x₀ and x₁ are movement profiles for respectively the main camera 10 and camera i combined from multiple frames, c₀ and cᵢ are functions equal to 1 when the camera sensor is exposed and, 0 when the sensor is not exposed.

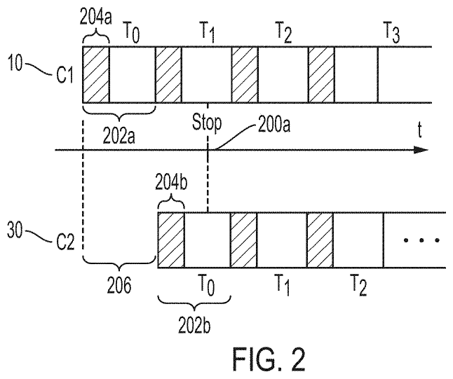

FIG. 2 is a conceptual diagram of an example stop event 200a that may be detected by the main camera 10 and one of the support cameras 30, and used for autocalibration of the one of the support cameras 30 using the rough autocalibration mechanism according to one embodiment. In the example of FIG. 2, the main camera 10 transmits a sequence of image frames 202a capturing images of an object 22 in the scene from a first viewpoint. The support camera 30 also transmits a sequence of image frames 202b capturing images of the object from a second viewpoint. Each image frame 202 has an exposure time 204a, 204b which, in the example of FIG. 2, is small (e.g. less than 50% of the frame time), so that no motion blur is assumed.

In one embodiment, each image frame 202 is associated with a timestamp (e.g. T0, T1, etc.). In the example of FIG. 2, the support camera 30 is offset from the main camera 10 by a single frame period T_{f} 206. In one embodiment, the autocalibration system 100 uses the stop event 200a that is captured by both cameras for calculating the autocalibration value for the support camera 30. In this regard, the main camera 10 detects the stop event as occurring at timestamp T1. The support camera 30, on the other hand, detects the stop event as occurring at timestamp T0. The autocalibration system 100 takes the timestamps T1 and T0 from the main camera and the support camera, and computes the autocalibration value as a difference of the two timestamps.

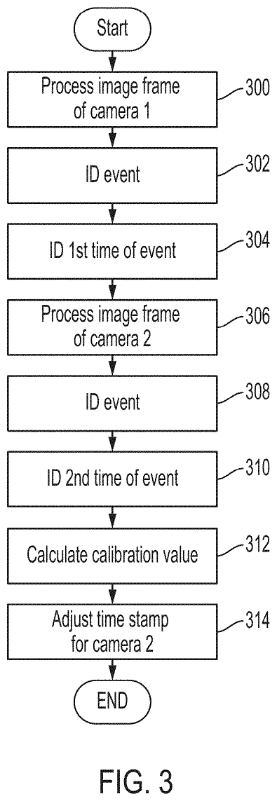

FIG. 3 is flow diagram of a process for rough temporal autocalibration of a second imaging device (e.g. support camera 30) to a first imaging device (e.g. main camera 10) according to one embodiment. The process starts, and at block 300, the autocalibration system 100 processes a first image frame transmitted by the first imaging device.

At block 302, the autocalibration system 100 identifies an event in the first image frame. The event may be, for example, start of motion of an object (e.g. object 22) on the carrier medium 24, stop of motion of the object, or the like. The event may be identified using any algorithm conventional in the art such as, for example, an optical flow algorithm that detects movement (or lack thereof) via change of position of brightness patterns associated with the object from one frame to the next. Another algorithm that may be employed for detecting the event may be a keypoint detection algorithm that may monitor the change of position of the keypoints (e.g. unique features) of the object from one frame to the next.

At block 304, the autocalibration system 100 identifies a first time of the event. The first time may be, for example, the timestamp of the first image frame that is given by the clock of the first imaging device.

The autocalibration system 100 attempts to identify the same event in an image frame captured by a second imaging device (e.g. support camera 30). In this regard, at block 306, the autocalibration system 100 processes a second image frame captured by a second imaging device (e.g. support camera 30), and at block 308, identifies the event that was detected by the first imaging device, in the second image frame.

At block 310, the autocalibration system 100 identifies a second time of the event. The second time may be, for example, the timestamp of the second image frame that is given by the clock of the second imaging device.

At block 312, the autocalibration system 100 calculates a calibration value based on a difference between the first time and the second time.

At block 314, the autocalibration system 100 adjusts a timestamp of a third image frame provided by the second imaging device based on the calibration value. In this manner, the image frames provided by the second imaging device may be synchronized to the image frames of the first imaging device.

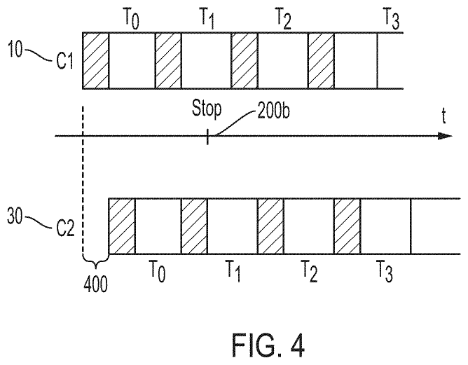

FIG. 4 is a conceptual diagram of an example of subframe time discrepancy between the main camera 10 and the support camera 30. The support camera 30 may be described as having a subframe time discrepancy 400 if the discrepancy is less than the time of a single image frame. In the example of FIG. 3, the time discrepancy between the main camera 10 and the support camera 30 is ⅓ of a single frame period. Thus, the main camera 10 may detect a stop event 200b as occurring at timestamp T1. Because of the subframe time discrepancy, the support camera 30 also detects the stop event 200b as occurring at timestamp T1. Thus, the rough autocalibration mechanism may not be sufficient for adjusting for such a subframe time discrepancy in the presence of a single calibration event. The subframe autocalibration mechanism, however, may be used for adjusting for subframe time discrepancies when multiple calibration events are detected.

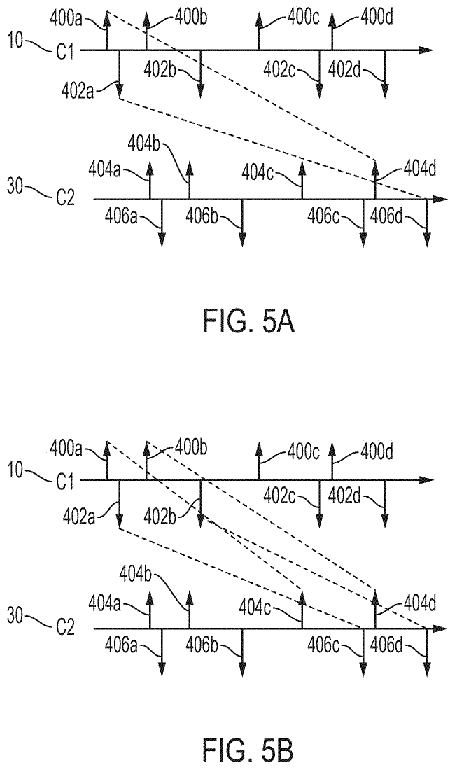

FIGS. 5A-5B are conceptual diagrams of a process for attempting different tentative alignment of events detected by the main camera 10 and one of the support cameras 30, for performing subframe autocalibration based on the optimal alignment according to one embodiment. In one example, the main camera 10 provides a sequence of image frames that capture calibration events such as start events 400a-400d (collectively referenced as 400) and stop events 402a-402d (collectively referenced as 402) of an object 22 transported by a carrying medium 24, over a span of time. In one embodiment, the time interval between these events are assumed to not be a multiple of the frame time.

The support camera 30 may also capture start events 404a-404d (collectively referenced as 404) and stop events 406a-406d (collectively referenced as 406) in a sequence of image frames that it provides during the same span of time. The start and stop events 404, 406 captured by of the support camera 30 may be the same start and stop events 400, 402 captured by the main camera, but from a different viewpoint. Although they are corresponding events, the events are assigned different timestamps by the main camera 10 and the support camera 30 because the main camera 10 and the support camera 30 are out of temporal calibration.

In one embodiment, the autocalibration system 100 engages in iterative tentative alignments of the start and stop events 400, 402 of the main camera 10, to the start and stop events 402, 404 of the support camera 30. In one example, the autocalibration system takes the first two events 400a, 402a of the main camera, and matches it to the last two events 404d, 406d of the support camera 30 (or vice versa), so that the start event 400a of the main camera 10 matches with the start event 404d of the support camera, and the stop event 402a of the main camera 10 matches with the stop event 406d of the support camera 30. In the case that the first tracked events of the first and support cameras 10, 30 are of a different type (e.g., a “stop” event in the main camera 10 and a “start” event in the support camera 30) and under the assumption that the types of events alternate between start and stop events, the autocalibration system 10 selects the second and third events instead of the first two. For example, the first tracked event for the main camera 10 may be a start of movement event while the first tracked event for the support camera 30 may be a stop of movement event.

In one embodiment, the autocalibration system 100 computes a temporary/tentative Δtᵢ based on the match. As discussed above, the tentative calibration value for camera i(Δtᵢ) (where i is the second camera) may be an average of the temporal discrepancies between the timestamps of the first and second plurality of events, according to the following equation:

$${Δ t}_{i} = \frac{{\sum }_{e} ( {t}_{e , 0} - {t}_{e , i} )}{n} ,$$

where n is the number of matched events, t_{e,0} is the timestamp of an event detected by the main camera 10, and t_{e,i} is the timestamp of a matched event detected by the second camera.

As also discussed above, the autocalibration system 100 may further calculate a temporary error value E based on the temporary Δtᵢ according to the below formula:

E=Σₑ(t_{e,0}−t_{e,i}−Δtᵢ)²

The error value may be saved in memory.

In one embodiment, the autocalibration system 100 attempts different alignments of the events of the support camera 30 that are earlier in time than the start and stop events 404d, 406d of the first iteration. In this regard, in performing a second alignment attempt, the process slides over to events earlier in time to attempt a match of the start event 400a with start event 404c, and a match of the stop event 402a with stop event 406d. In addition, additional matches are also attempted in the second iteration as more events become available for the support camera 30 for attempting the match. For example, a match may also be attempted between the start event 400b of the main camera 10 and the start event 404d of the support camera 30, and between the stop event 402b of the main camera 10 and the stop event 406d of the support camera 30.

In one embodiment, the autocalibration system 100 computes a second Δtᵢ based on the second alignment attempt. In this regard, the computed Δtᵢ may be an average of the discrepancies of the four matched events during the current iteration. The autocalibration system 100 may also calculate a new error value E using the newly computed Δtᵢ. The new error value may be compared against the stored error value for identifying a smaller one of the compared error values. Alternatively, the new error value is stored until all alignment possibilities have been attempted, and a minimal error value of the stored error values is selected as reflecting the correct alignment of events.

In one embodiment, the iterative alignment attempts continue by sliding the timeframe of the events of the main and support cameras to tentatively align the events until all alignment possibilities have been attempted. The error values corresponding to the alignment attempts are also computed based on the matches attempted during the alignment. The Δtᵢ associated with the minimal error value is identified as the autocalibration value for the support camera.

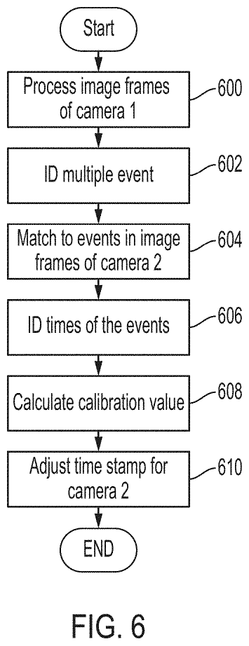

FIG. 6 is flow diagram of a process for subframe temporal autocalibration of a second imaging device (e.g. support camera 30) to a first imaging device (e.g. main camera 10) according to one embodiment. The process starts, and at block 600, the autocalibration system 100 processes a first sequence of image frames transmitted by the first imaging device.

At block 602, the autocalibration system 100 identifies a first plurality of events in the first sequence. For example, the event may be multiple start events (e.g. starts of motion of an object on the carrier medium 24), multiple stop events (e.g. stops of motion of the object on the carrier medium 24), and/or the like. The events may be identified using any algorithm conventional in the art such as, for example, an optical flow algorithm, keypoint detection algorithm, and/or the like.

At block 604, the autocalibration system 100 processes a second sequence of image frames transmitted by a second imaging device (e.g. the support camera), and selects a second plurality of events as a match to the first plurality of events. In one embodiment, the selection of the second plurality of events is such that the discrepancy (e.g. an error measure) between the first plurality of events and the second plurality of events are minimized. In finding a match that minimizes the error measure, the autocalibration system 100 may be configured to try different matches in an iterative manner until all matches have been attempted, as discussed with reference to FIGS. 4A-4B. Of course, any other minimization algorithm conventional in the art may also be employed.

At block 606, the autocalibration system 100 identifies a first plurality of time values corresponding to the first plurality of events, and a second plurality of time values corresponding to the second plurality of events. The time values may be, for example, timestamps of the image frames capturing the events.

At block 608, the autocalibration system 100 calculates a calibration value based on an average of the differences between the first plurality of time values and the second plurality of time values.

At block 610, the autocalibration system 100 adjusts a timestamp of a third image frame provided by the second imaging device based on the calibration value. In this manner, the image frames provided by the second imaging device may be synchronized to the image frames of the first imaging device.

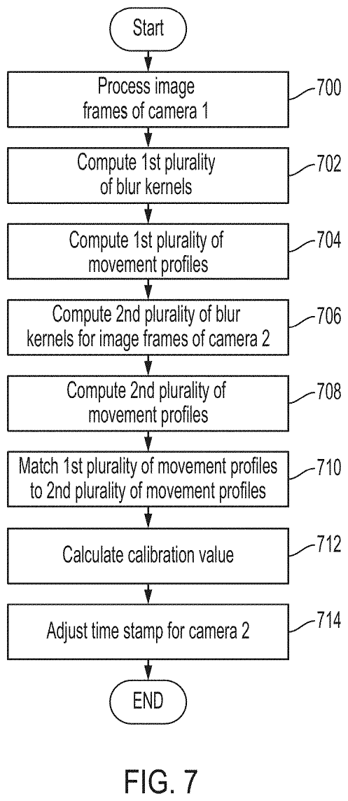

FIG. 7 is flow diagram of a process for temporal autocalibration of a second imaging device (e.g. support camera 30) to a first imaging device (e.g. main camera 10) in the presence of motion blur according to one embodiment. The process starts, and at block 700, the autocalibration system 100 processes a first sequence of image frames transmitted by the first imaging device. In one embodiment, the autocalibration system 100 detects that one or more of the first sequence of images frames includes motion-blurred images due to movement of an object (e.g. object 22) on the carrier medium 24. In one embodiment, the autocalibration system 100 may assume presence of motion blur when a camera exposure time is bigger than a threshold value (e.g. bigger than 50% of the frame time).

At block 702, the autocalibration system 100 computes a first plurality of blur kernels k for the first sequence of image frames. Each blur kernel may be an N×N convolution matrix that encodes the movement of the camera and/or objects in the scene. When the blur kernel k is applied to the latent sharp image I₀, it recreates the captured blurred image I as follows:

I=I₀*k

where * indicates a convolution operation.

In one embodiment, the movements of the camera and/or objects are linear movements through the scene. In more detail, in some embodiments of the present disclosure, it is assumed that the camera remains stationary or fixed and the motion blur arises only from the (linear) movements of objects in the scene imaged by the camera. Given such linear movements, each blur kernel may appear as a linear stroke that may be converted to a 1D movement profile characterizing the movement of the object during the exposure time of the corresponding image frame. Accordingly, at block 704, the autocalibration system 100 computes a first plurality of movement profiles for the first plurality of blur kernels.

At block 706, the autocalibration system 100 computes a second plurality of blur kernels for a second sequence of image frames.

At block 708, the autocalibration system 100 computes a second plurality of movement profiles for the second plurality of blur kernels.

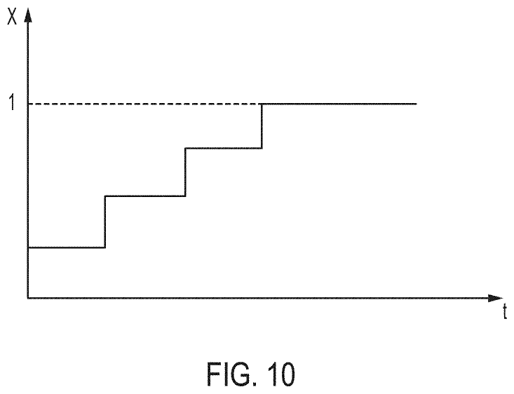

At block 710, the autocalibration system 100 matches the first plurality of movement profiles to the second plurality of movement profiles. In this regard, the autocalibration system 100 may combine/stack the movement profiles of each frame of the corresponding camera (see, e.g. FIG. 10), and create a single, combined movement profile of the object for the camera over the time period of the sequence of image frames.

At block 712, the autocalibration system 100 calculates a calibration value Δti so that the value minimizes an error value for all movement profiles (e.g., the difference between the movement profile of the object as captured by the main camera and each of the movement profiles of the object as captured by the support cameras i) combined:

E=Σᵢc₀cᵢ(Δtᵢ)(x₀−xᵢ(Δtᵢ)),

At block 714, the autocalibration system 100 adjusts a timestamp of a third image frame provided by the second imaging device based on the calibration value. In this manner, the image frames provided by the second imaging device may be synchronized to the image frames of the first imaging device.

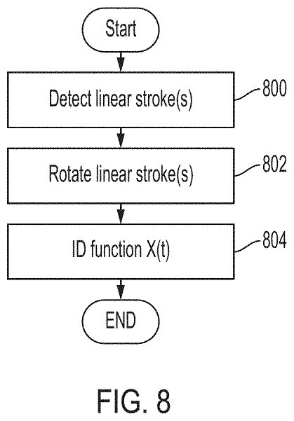

FIG. 8 is a more detailed flow diagram of the steps in blocks 704 and 708 for computing a one-dimensional (1D) movement profile based on a blur kernel according to one embodiment. The process starts, and at block 800, the autocalibration module 100 detects one or more linear strokes in the kernel.

At block 802, the autocalibration module 100 rotates the one or more linear strokes, as needed, so that they lie on a horizontal line. In particular, the different cameras capture images of the scene from different viewpoints. Based on the poses (position and orientation) of the cameras, the same moving object may appear to be moving in different directions with respect to the image frames captured by the different cameras. For example, a main camera located level with the moving object may detect motion blur due to the object moving left to right from the viewpoint of the main camera, while a support camera located above (and looking down at) the moving object may detect motion blue due to the object moving top to bottom from the viewpoint of the support camera. Therefore, the blur kernel computed from the image frame of the main camera may be horizontal line due to the left-to-right motion, whereas the blur kernel computed from the image frame captured by the support camera may be a vertical line due to the top-to-bottom motion. In a similar way, a third camera having an above-side view of the object may have a viewpoint where the object moves diagonally through its field of view, and the motion blur kernel may therefore be a diagonal line along the direction of motion of the object through the image frame. Therefore, in one embodiment, the autocalibration module 100 rotates the linear strokes of the motion blur kernels corresponding to the different cameras to a common direction (e.g., a horizontal direction) to convert the 2D motion profiles represented by the motion blur kernels into 1D motion profiles. In one embedment, the length of the linear stroke corresponds to the speed of the linear motion of the object during a frame. For example, a stopped object has no motion blur and therefore the motion blur kernel will have zero length, and a fast moving object will have a large amount of motion blur and therefore the motion blur kernel will be long. A vector of values (e.g. [0.3, 0.4, 0.4, 0.9]) is identified based on the lengths of the one or more linear strokes.

At block 804, a function x(t) is identified by inverting the vector of values. In this regard, the vector is normalized, such as by dividing the vector values by the sum of all the values of the vector (e.g. 2 for the above example). In the above example of vector values, the result of the normalization is [0.15, 0.2, 0.2, 0.45]. The normalization may be performed because the different viewpoints of the different cameras may cause the lengths of the strokes to be different (e.g., given two cameras having the same field of view, a camera that is closer to the object will observe more motion blur than a camera farther away from the object). The exposure time for the frame is multiplied by each vector value representing a normalized speed of the object during each frame. For example, if the exposure time is 100 ms, the values in the example above are: [15, 20, 20, 45]. The function x(t) may define the movement profile in the following way:

$$x ( t ) = \{ \frac{1}{len ( vec ( T ) )} , \\ for \\ t ∈ [ 0 , T [ 0 ] ] ; \\ \frac{2}{len ( vec ( T ) )} , \\ for \\ t ∈ [ T [ 0 ] , T [ 1 ] ] ; \\ \frac{3}{len ( vec ( T ) )} , \\ for \\ t ∈ [ T [ 1 ] , T [ 2 ] ] ;$$

In the above example, x(t)={0.25 for t∈[0,15], 0.5 for t∈[15, 35], 0.75 for t∈[35, 55], 1 for t∈[55,100].

It should be understood that the sequence of steps of the process in any of FIGS. 5-8 is not fixed, but can be modified, changed in order, performed differently, performed sequentially, concurrently, or simultaneously, or altered into any desired sequence, as recognized by a person of skill in the art.

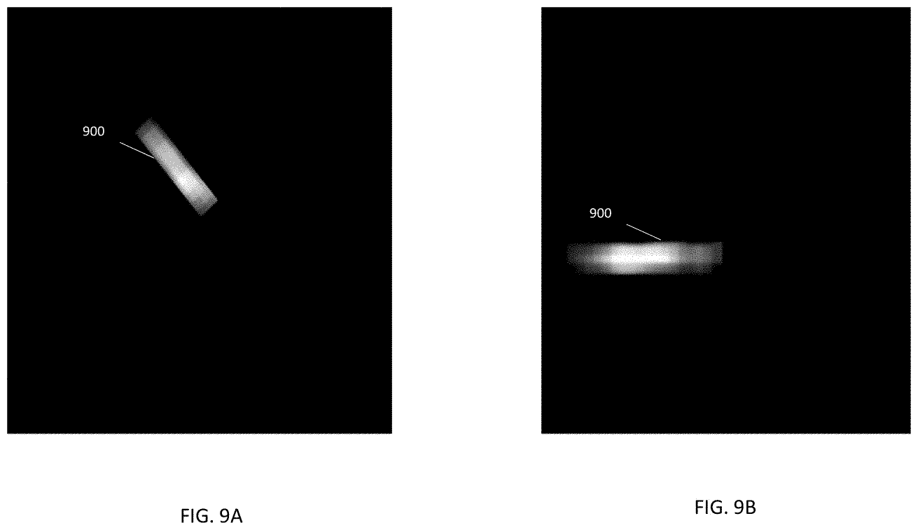

FIGS. 9A-9B are pictures of exemplary motion blur kernels according to one embodiment. The motion blur kernel of FIG. 9A depicts a linear stroke 900 generated by an object moving linearly in a diagonal direction. FIG. 9B depicts the motion blur kernel of FIG. 9A, but with the linear stroke 900 rotated to be in a horizontal direction.

FIG. 10 is a graph of an example 1D movement profile according to one embodiment. In the example of FIG. 10, the movement profile is defined by a step function.

Once the support cameras 30 are temporally calibrated to the main camera 10, the image frames provided by the cameras 10, 30 may be used for estimating the six-degree-of-freedom (6-DoF) poses of objects in a scene, and/or the moving direction and speed of the objects. Such information may be useful in various applications such as robotics. For example, such information may be provided to a robot controller for improving situational awareness and enabling the robot controller to interact appropriately with the environment, in accordance the particular tasks assigned to the robot. As a further example, autonomously navigating robots or vehicles may maintain information about the poses of objects in a scene in order to assist with navigation around those objects in order to predict trajectories and to avoid collisions with those objects. As another example, in the case of manufacturing, pose estimation may be used by robotic systems to manipulate the workpieces and place and/or attach components to those workpieces.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for calibrating an imaging device comprising:
processing, by a processing circuit, a first image frame captured by a first imaging device;
identifying, by the processing circuit, an event in the first image frame;
determining, by the processing circuit, a first time value of the event;
processing, by the processing circuit, a second image frame captured by a second imaging device;
identifying, by the processing circuit, the event in the second image frame;
determining, by the processing circuit, a second time value of the event;
calculating, by the processing circuit, a calibration value based on a difference between the first time value and the second time value; and
adjusting, by the processing circuit, a time value of a third image frame provided by the second imaging device based on the calibration value.

2. The method of claim 1, wherein the event is a start or stop of movement of an object through a scene.

3. The method of claim 1, wherein the first time value is a first timestamp of the first image frame, and the second time value is a second timestamp of the second image frame.

4. A method for calibrating an imaging device comprising:
processing, by a processing circuit, a first sequence of image frames transmitted by a first imaging device;
identifying, by the processing circuit, a first plurality of events in the first sequence;
processing, by the processing circuit, a second sequence of image frames transmitted by a second imaging device;
selecting, by the processing circuit, a second plurality of events in the second sequence that minimizes discrepancy between the first plurality of events and the second plurality of events;
determining, by the processing circuit, a first plurality of time values corresponding to the first plurality of events, and a second plurality of time values corresponding to the second plurality of events;
computing, by the processing circuit, a calibration value based on a difference between the first plurality of time values and the second plurality of time values; and
adjusting, by the processing circuit, a time value of a third image frame provided by the second imaging device based on the calibration value.

5. The method of claim 4, wherein the first plurality of events include start and stop movements of an object through a scene.

6. The method of claim 4, wherein the first plurality of time values include timestamps of the first sequence of image frames, and the second plurality of time values include timestamps of the second sequence of image frames.

7. The method of claim 4, wherein the calibration value is an average of a first difference and a second difference, wherein the first difference is between times of first events selected from the first plurality of events and the second plurality of events, and the second difference is between times of second events selected from the first plurality of events and the second plurality of events.

8. The method of claim 4, wherein the selecting of the second plurality of events includes iteratively aligning the first plurality of events to different ones of the second plurality of events, and iteratively computing discrepancy measurements based on the aligning.

9. A method for calibrating an imaging device comprising:
processing, by a processing circuit, a first sequence of image frames transmitted by a first imaging device, wherein one or more of the first sequence of image frames includes first motion-blurred images;
computing, by the processing circuit, a first blur kernel for a first image frame in the first sequence of image frames;
computing, by the processing circuit, a first movement profile for the first blur kernel;
processing, by a processing circuit, a second sequence of image frames transmitted by a second imaging device, wherein one or more of the second sequence of image frames includes second motion-blurred images;
computing, by the processing circuit, a second blur kernel for a second image frame in the second sequence of image frames;
computing, by the processing circuit, a second movement profile for the second blur kernel;
computing, by the processing circuit, a calibration value that minimizes discrepancy between the first movement profile and the second movement profile; and
adjusting, by the processing circuit, a timestamp of a third image frame provided by the second imaging device based on the calibration value.

10. The method of claim 9, wherein the first movement profile and the second movement profile encode linear movements.

11. An imaging system comprising:
a first imaging device;
a second imaging device; and
a processing system coupled to the first imaging device and the second imaging device, the processing system comprising a processor and memory storing instructions that, when executed by the processor, cause the processor to perform:
processing a first image frame captured by a first imaging device;
identifying an event in the first image frame;
determining a first time value of the event;
processing a second image frame captured by a second imaging device;
identifying the event in the second image frame;
determining a second time value of the event;
calculating a calibration value based on a difference between the first time value and the second time value; and
adjusting a time value of a third image frame provided by the second imaging device based on the calibration value.

12. The imaging system of claim 11, wherein the event is a start or stop of movement of an object through a scene.

13. The imaging system of claim 11, wherein the first time value is a first timestamp of the first image frame, and the second time value is a second timestamp of the second image frame.

14. An imaging system comprising:
a first imaging device;
a second imaging device; and
a processing system coupled to the first imaging device and the second imaging device, the processing system comprising a processor and memory storing instructions that, when executed by the processor, cause the processor to perform:
processing a first sequence of image frames transmitted by a first imaging device;
identifying a first plurality of events in the first sequence;
processing a second sequence of image frames transmitted by a second imaging device;
selecting a second plurality of events in the second sequence that minimizes discrepancy between the first plurality of events and the second plurality of events;
determining a first plurality of time values corresponding to the first plurality of events, and a second plurality of time values corresponding to the second plurality of events;
computing a calibration value based on a difference between the first plurality of time values and the second plurality of time values; and
adjusting a time value of a third image frame provided by the second imaging device based on the calibration value.

15. The imaging system of claim 14, wherein the first plurality of events include start and stop movements of an object through a scene.

16. The imaging system of claim 14, wherein the first plurality of time values include timestamps of the first sequence of image frames, and the second plurality of time values include timestamps of the second sequence of image frames.

17. The imaging system of claim 14, wherein the calibration value is an average of a first difference and a second difference, wherein the first difference is between times of first events selected from the first plurality of events and the second plurality of events, and the second difference is between times of second events selected from the first plurality of events and the second plurality of events.

18. The imaging system of claim 14, wherein the selecting of the second plurality of events includes iteratively aligning the first plurality of events to different ones of the second plurality of events, and iteratively computing discrepancy measurements based on the aligning.

19. An imaging system comprising:
a first imaging device;
a second imaging device; and
a processing system coupled to the first imaging device and the second imaging device, the processing system comprising a processor and memory storing instructions that, when executed by the processor, cause the processor to perform:
processing a first sequence of image frames transmitted by a first imaging device, wherein one or more of the first sequence of image frames includes first motion-blurred images;
computing a first blur kernel for a first image frame in the first sequence of image frames;
computing a first movement profile for the first blur kernel;
processing a second sequence of image frames transmitted by a second imaging device, wherein one or more of the second sequence of image frames includes second motion-blurred images;
computing a second blur kernel for a second image frame in the second sequence of image frames;
computing a second movement profile for the second blur kernel;
computing a calibration value that minimizes discrepancy between the first movement profile and the second movement profile; and
adjusting a timestamp of a third image frame provided by the second imaging device based on the calibration value.

20. The imaging system of claim 19, wherein the first movement profile and the second movement profile encode linear movements.
